(19) United States
(12) Patent Application Publication
(10) Pub. No.: US 2011/0276405 A1
(43) Pub. Date: Nov. 10, 2011

(54) COMBINATORIAL ADVERTISEMENTS

(75) Inventors: VISWANATH VADLAMANI, REDMOND, WA (US); TAREK NAJM, KIRKLAND, WA (US)

(73) Assignee: MICROSOFT CORPORATION, REDMOND, WA (US)

(21) Appl. No.: 12/777,007

(22) Filed: May 10, 2010

(51) Int. Cl. G06Q 30/00

(52) U.S. Cl. 705/14.66; 705/14.72; 705/14.49

(57) ABSTRACT

Combinatorial advertisements are provided based on textual advertisements and rich media advertisements. A textual advertisement and rich media advertisement are identified as matching. Based on identifying the textual advertisement and rich media advertisement as matching, a combinatorial advertisement is generated. The combinatorial advertisement includes a text portion derived from text from the textual advertisement. Additionally, the combinatorial advertisement includes a rich media portion derived from rich media from the rich media advertisement.

### BACKGROUND

Online advertising has become a significant aspect of computing environments, as it presents a powerful way for advertisers to market their products and services. For instance, online advertising is often more likely to allow advertisers to effectively deliver advertisements to their target audiences as compared with traditional media advertising, such as newspapers, magazines, and radio. Additionally, there are a variety of advertisement systems and methods for delivering online advertisements for presentation to users. Generally, online advertising includes any form of advertising that uses computer network environments to deliver advertisements and other marketing messages to potential customers. For instance, advertisements may be presented within web pages, search engine search results, online video games, advertisement-based software applications, and email messages, to name a few. A wide variety of additional approaches and environments exist for delivering online advertising for presentation to users. Additionally, electronic advertisements may range from simple text-based advertisements to rich media advertisements, which are capable of numerous features including playing sound and/or video, expanding, and animation.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing combinatorial advertisements for presentation in electronic advertising environments. A combinatorial advertisement is generated by an advertisement delivery system by combining text from a textual advertisement and rich media from a rich media advertisement. The advertisement delivery system identifies a textual advertisement and a rich media advertisement as matching. Based on the identification, a combinatorial advertisement is generated from text of the textual advertisement and rich media from the matching rich media advertisement. The combinatorial advertisement may be provided in response to a request for an advertisement for presentation in an electronic environment. The combinatorial advertisement displays the text from the textual advertisement and allows for presentation of the rich media from the rich media advertisement.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed;

FIG. 3 is a block diagram of an exemplary advertisement delivery system in accordance with an embodiment of the present invention;

FIG. 4 is an illustrative combinatorial advertisement generated in accordance with an embodiment of the present invention;

FIG. 5 is a flow diagram showing a method for generating a combinatorial advertisement in accordance with an embodiment of the present invention;

FIG. 6 is a flow diagram showing a method for providing a combinatorial advertisement in response to a request for an advertisement in accordance with an embodiment of the present invention;

FIG. 7 is a flow diagram showing a method for providing a combinatorial advertisement in response to a request for an advertisement in accordance with an embodiment of the present invention; and

FIG. 8 is a flow diagram showing a method for updating a combinatorial advertisement in response to a detected user action in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As previously indicated, embodiments of the present invention are generally directed to providing combinatorial advertisements generated from a combination of textual advertisements and rich media advertisements. As used herein, the term “textual advertisement” generally refers to an advertisement that includes text without rich media. Additionally, as used herein, the term “rich media advertisement” refers to an advertisement that includes rich media capable of any of a number of different features, such as playing sound and/or video, expanding, and animation.

In accordance with embodiments of the present invention, a textual advertisement and rich media advertisement may be identified as matching such that it would make sense to combine the advertisements to generate a combinatorial advertisement. Generally, advertisements may be identified as matching based on being associated with the same advertisement, being directed to similar content, and/or any other factor that may indicate that the advertisements may provide a coordinated advertising message.

Based on identifying a textual advertisement and rich media advertisement as matching, a combinatorial advertisement may be generated. The combinatorial advertisement may be generated by including a text portion derived from text from the textual advertisement and a rich media portion derived from rich media from the rich media advertisement. While embodiments are discussed herein primarily in which a single textual advertisement and single rich media advertisement are identified as matching and combined to generate a combinatorial advertisement, a combinatorial advertisement may be generated based on more than a single textual advertisement and a single rich media advertisement. For instance, a combinatorial advertisement may be generated using the text from a single textual advertisement but including rich media from multiple rich media advertisements.

When an advertisement delivery system receives a request for an advertisement, the advertisement delivery system may return one or more advertisements for presentation, including one or more combinatorial advertisements. The electronic environments in which advertisements may be delivered include, for instance, search results, web pages, online games, advertisement-supported software applications, and emails. In some embodiments, the combinatorial advertisement is sized to occupy the space allocated within the electronic environment for a single advertisement. For instance, the electronic environment may allocate a space for presenting an advertisement of a certain size, and the combinatorial advertisement may be generated in accordance with that size.

In some embodiments, the advertisement delivery system may deliver any combination of textual advertisements, rich media advertisements, and/or combinatorial advertisements in response to requests for advertisements. In other words, while combinatorial advertisements generated from matching textual advertisements and rich media advertisements may be provided in response to some requests, the textual advertisements and rich media advertisements used to generate the combinatorial advertisements may also be provided in response to those requests or other requests. As such, in some embodiments, the textual advertisements and rich media advertisements are not used solely for generating combinatorial advertisements, but may also be individually selected and delivered for presentation. The selection of textual advertisements, rich media advertisements, and/or combinatorial advertisements in response to any given request may be based on a variety of factors, including the environment in which the advertisements are to be presented and ranking of the advertisements.

Accordingly, in one aspect, an embodiment of the present invention is directed to one or more computer-readable media storing computer-useable instructions that, when used by one or more computing devices, cause the one or more computing devices to perform a method. The method includes identifying a textual advertisement and rich media advertisement as matching. The method also includes generating a combinatorial advertisement based on identifying the textual advertisement and rich media advertisement as matching, the combinatorial advertisement including a text portion based on text from the textual advertisement and a rich media portion based on rich media from the rich media advertisement.

In another embodiment, an aspect of the invention is directed to one or more computer-readable media storing computer-useable instructions that, when used by one or more computing devices, cause the one or more computing devices to perform a method. The method includes receiving a request for an advertisement. The method also includes identifying a textual advertisement and a rich media advertisement as matching and as satisfying the request. The method further includes providing a combinatorial advertisement based on the textual advertisement and the rich media advertisement, the combinatorial advertisement including a text portion based on text from the textual advertisement and a rich media portion based on rich media from the rich media advertisement. The method still further includes providing the combinatorial advertisement for presentation to an end user.

A further embodiment of the present invention is directed to one or more computer-readable media storing computer-useable instructions that, when used by one or more computing devices, cause the one or more computing devices to provide a combinatorial advertisement. The combinatorial advertisement includes a text portion comprising text derived from a textual advertisement. The combinatorial advertisement also includes a rich media portion comprising rich media derived from a rich media advertisement. The combinatorial advertisement is generated based on a determination that the textual advertisement and rich media advertisement are matching.

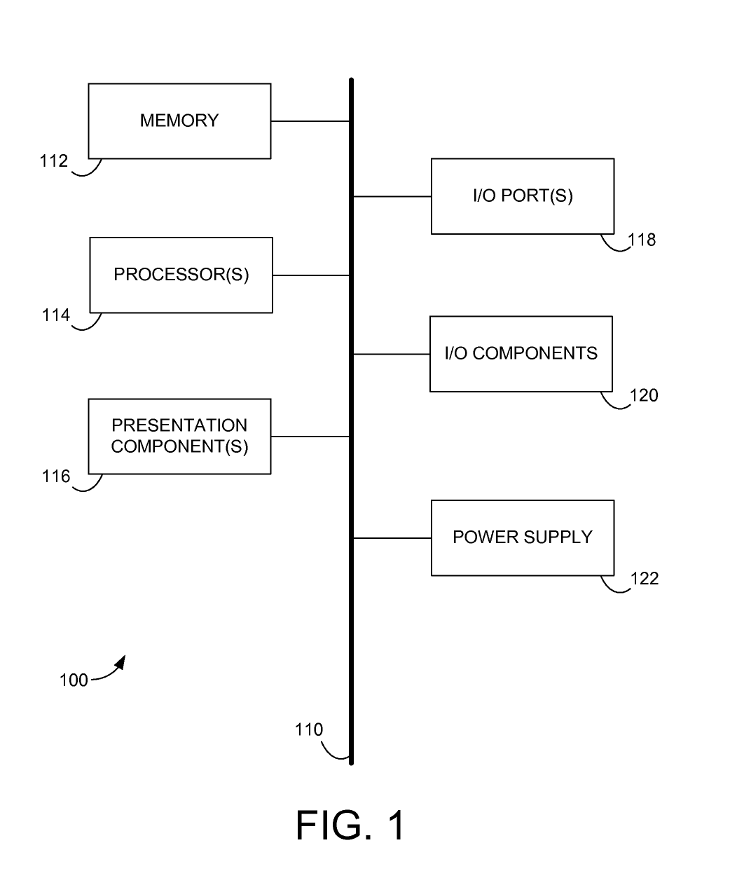

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to an end user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

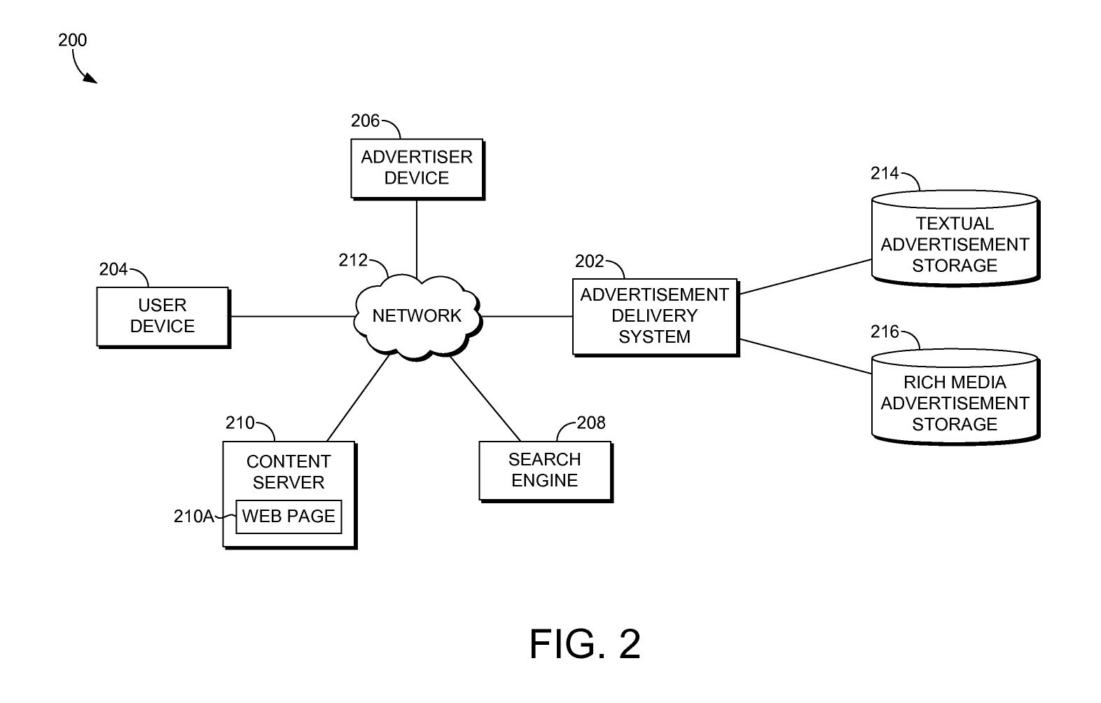

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 includes an advertisement delivery system 202, a user device 204, an advertiser device 206, a search engine 208, and a content server 210. Each of the components shown in FIG. 2 may be any type of computing device, such as computing device 100 described with reference to FIG. 1, for example. The components may communicate with each other via a network 212, which may include, without limitation, one or more local area networks (LANs) and/or wide area networks (WANs). Such networking environments are commonplace in offices, enterprise-wide computer networks, intranets, and the Internet. It should be understood that any number of advertisement delivery systems, user devices, advertiser devices, search engines, and content severs may be employed within the system 200 within the scope of the present invention. Each may comprise a single device or multiple devices cooperating in a distributed environment. For instance, the advertisement delivery system 202 may comprise multiple devices arranged in a distributed environment that collectively provide the functionality of the advertisement delivery system 202 described herein. Additionally, other components not shown may also be included within the system 200 and components shown in FIG. 2 may be excluded in some embodiments.

In accordance with embodiments of the present invention, the advertisement delivery system 202 generally operates to facilitate the selection and delivery of advertisements to user devices, such as the user device 204. Additionally, the advertisement delivery system 202 operates to identify matching textual advertisements and rich media advertisements and to generate combinatorial advertisements based on matching textual advertisements and rich media advertisements.

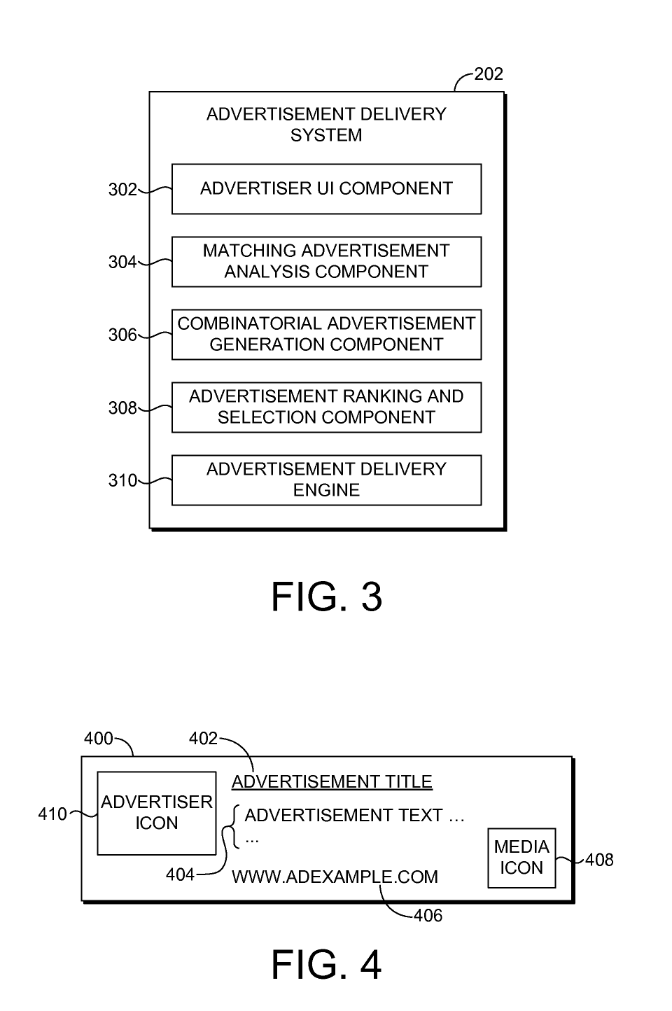

As shown in FIG. 3, the advertisement delivery system 202 includes, among other components not shown, an advertiser UI component 302, a matching advertisement analysis component 304, a combinatorial advertisement generation component 306, an advertisement ranking and selection component 308, and an advertisement delivery engine 310.

The advertiser UI component 302 generally provides one or more UIs to advertisers to allow the advertisers to interact with the advertisement delivery system 202. For instance, an advertiser may employ a computing device, such as the advertiser device 206, to access the advertiser UI component 302 of the advertisement delivery system 202 via network 212.

In one embodiment, the advertiser UI component 302 provides one or more UIs that allow an advertiser to create a new advertising campaign and/or edit an existing advertising campaign. The UI(s) provided for creating and/or editing an advertising campaign allows the advertiser to specify information for the advertising campaign. This may include submitting and/or editing information for one or more advertisements. For instance, the UI(s) may allow the advertiser to provide textual advertisements and/or rich media advertisements. Additionally, the UI(s) may allow the advertiser to provide information regarding submitted advertisements. For instance, in some embodiments, the advertiser UI component 302 may allow the advertiser to identify to the advertisement delivery system 202 matching textual advertisements and rich media advertisements to facilitate the generation of combinatorial advertisements. Additionally, the advertisement UI component 302 may allow the advertiser to provide an advertiser icon to be included on a combinatorial advertisement.

The advertiser UI component 302 may further provide one or more UIs that allow an advertiser to submit bidding information for textual advertisements and rich media advertisements. The bidding information specifies the amount of money the advertiser will pay the advertisement delivery system provider for delivery of the advertiser's advertisements. Additionally, the bidding information may be used by the advertisement delivery system 202 to select advertisements for presentation based on relevance and/or monetization. The various bid factors that may be provided by an advertiser may include, but are not limited to, cost-per-impression-bids (CPI), cost-per-click (CPC) bids, cost-per-performance (CPP) bids, and the like. A CPI bid, as used herein, refers to an amount that an advertiser is willing to pay for each impression of their advertisement, i.e., each time its advertisement is displayed. A CPC bid, as used herein, refers to an amount an advertiser is willing to pay each time its ad is selected or “clicked” by a user. A CPP bid, as used herein, refers to an amount an advertiser is willing to pay once a user performs some action after selecting its advertisement. For instance, a user may purchase the advertiser's product upon selecting the advertisement. In some embodiments, an advertiser may provide additional bidding information for combinatorial advertisements. For instance, an advertiser may be willing to pay an additional amount for a combinatorial advertisement to be delivered by the advertisement delivery system 202.

Advertisement information entered by an advertiser via UI(s) provided by the advertiser UI component 302 is stored by the advertisement delivery system 204 in textual advertisement storage 214 and/or rich media advertisement storage 216, referenced in FIG. 2. Accordingly, the textual advertisement storage 214 and rich media advertisement storage 216 store a variety of textual and rich media advertisements submitted by different advertisers, along with metadata for each advertisement that, among other things, facilitates selecting advertisements for presentation to users. While the system 200 is shown having two separate advertisement storages 214 and 216, it should be understood that any number of storage systems may be employed for storing textual and rich media advertisements in various embodiments of the present invention.

The advertisement delivery system 202 also includes a matching advertisement analysis component 304 that facilitates identifying matching textual advertisements and rich media advertisements. As noted above, in some instances, an advertiser may manually identify a textual advertisement and rich media advertisement as matching. In other instances, the matching advertisement analysis component 304 automatically analyzes textual advertisements and rich media advertisements, including associated metadata, to identify matching textual advertisements and rich media advertisements. The matching advertisement analysis component 304 may identify a textual advertisement and rich media advertisement as matching based on any number of different factors. By way of example only and not limitation, the factors that may be employed to identify matching textual advertisements and rich media advertisements may include whether the advertisements correspond with the same advertiser, whether similar keywords were bid on for each advertisement, text included within each advertisement, as well as other metadata associated with the advertisements.

The combinatorial advertisement generation component 306 operates to generate combinatorial advertisements based on matching textual advertisements and rich media advertisements. A combinatorial advertisement generated by the combinatorial advertisement generation component 306 includes a text portion based on a textual advertisement and a rich media portion based on a matching rich media advertisement. When a combinatorial advertisement is presented to an end user, the text derived from the textual advertisement is displayed. Additionally, in some embodiments, an indication that the combinatorial advertisement includes rich media may also be presented. For instance, an icon may be presented in the combinatorial advertisement that indicates the advertisement includes rich media. As another example, when the rich media is a video, the background of the combinatorial advertisement may be a frame from the video over which the text derived from the textual advertisement is displayed. When the user interacts with the combinatorial advertisement, the user may access the rich media portion derived from the rich media advertisement. For instance, the user may access the rich media by hovering a cursor over the combinatorial advertisement or selecting a potion of the combinatorial advertisement, such as an icon presented to indicate the presence of rich media.

An example of a combinatorial advertisement 400 is illustrated in FIG. 4. As shown in FIG. 4, the combinatorial advertisement 400 comprises a text portion, which includes a title 402, the advertisement's main body text 404, and a URL 406 corresponding with the advertiser or a landing page associated with the advertisement. In the present example, the combinatorial advertisement 400 also includes a rich media icon 408 that indicates to the user that the combinatorial advertisement includes rich media. The user may access the rich media, for instance, by clicking the rich media icon 408. As noted above, in other embodiments, other mechanisms may be employed to indicate to the user that the advertisement includes rich media. For instance, when the rich media is a video, a frame from the video may be displayed as background in the combinatorial advertisement 400. In further embodiments, an indication of rich media may not be presented, and the user may discover the rich media by interacting with the advertisement, for instance, by hovering a cursor over the advertisement or clicking on a portion of the advertisement. The rich media may be presented within the border of the advertisement or may expand beyond the border of the advertisement.

In some embodiments of the present invention, in addition to a text portion and rich media portion, the combinatorial advertisement 400 includes an advertiser icon 410 to indicate to the user the advertiser associated with the combinatorial advertisement 400. In some instances, an advertiser icon may be provided by an advertiser when providing an advertisement, and the advertiser-provided advertiser icon may be employed when generating the combinatorial advertisement 400. In other instances, an advertiser icon may be retrieved, for instance, from a web page associated with the advertiser or, more specifically, a landing page associated with the combinatorial advertisement 400. In some embodiments, a favicon from such a web page is employed as the advertiser icon.

Returning to FIG. 3, the matching advertisement analysis component 304 may analyze and identify matching advertisements at various points in time in accordance with the scope of embodiments of the present invention. For instance, in some embodiments, the matching advertisement analysis component 304 may analyze advertisements when submitted by advertisers. In some embodiments, the matching advertisement analysis component 304 may periodically analyze stored advertisements independent of requests for advertisements for presentation. In further embodiments, the matching advertisement analysis component 304 may analyze advertisements in response to receiving a request for an advertisement for presentation. Any and all such variations are contemplated to be within the scope of embodiments of the present invention. In some embodiments, when matching advertisements are identified, the advertisement delivery system 202 may store information identifying a matching textual advertisement and rich media advertisement.

Likewise, the combinatorial advertisement generation component 306 may generate combinatorial advertisements at various points in time in different embodiments of the present invention. Generally, a combinatorial advertisement may be generated whenever a matching textual advertisement and rich media advertisement are identified. In some embodiments, combinatorial advertisements may be generated independent of requests for advertisements and stored such that the generated combinatorial advertisements may be used in response to future requests for advertisements. In some embodiments, combinatorial advertisements may be generated in response to a request for an advertisement for presentation. Any and all such embodiments are contemplated to be within the scope of embodiments of the present invention.

The advertisement ranking and selection component 308 facilitates the selection and ranking of advertisements in response to requests for advertisements. In particular, when a request is received for an advertisement to be delivered to any of a variety of different environments (e.g., within search results, on web pages, or within other electronic environments), the advertisement ranking and selection component 308 selects advertisements to return in response to the request. The advertisement ranking and selection component 308 may return one or more advertisements in response to a request. In some embodiments, the advertisement ranking and selection component 308 may consider the different types of advertisements, including textual advertisements, rich media advertisements, and combinatorial advertisements, against one another. In instances in which multiple advertisements are returned in response to a request, the advertisements may be of a particular type of advertisement or may include advertisements of different types. In embodiments in which different types of advertisements may be selected for presentation, it's possible that the textual advertisement and/or rich media advertisement used to generate a combinatorial advertisement may be selected in addition to the combinatorial advertisement. In some embodiments, the system may be configured such that only the combinatorial advertisement is presented.

The advertisement ranking and selection component 308 may rank advertisements based on a variety of different factors, including, for instance, contextual relevance and monetization considerations. Contextual relevance refers to the relevance of each advertisement to the context of the environment in which the advertisement will be presented. Monetization considerations are based on an estimation of an amount of revenue that an advertisement delivery system may expect as a result of selecting and displaying a particular advertisement. Monetization considerations may include a variety of factors including, but not limited to, CPI bids, CPC bids, CPP bids, click-through rates, etc. In some embodiments, the ranking for a combinatorial advertisement may be based on a combination of ranking elements from the underlying textual advertisement and rich media advertisement for the combinatorial advertisement.

After ranking advertisements in response to a request, one or more advertisements are selected for presentation based on the rankings. In some embodiments, the top N advertisements are selected for presentation. In other embodiments, advertisements satisfying a particular threshold of ranking are selected. In further embodiments, advertisements having a ranking that is significantly greater than the ranking of other advertisements are selected. Any and all such variations are contemplated to be within the scope of embodiments of the present invention. After one or more advertisements have been selected for presentation, the advertisement delivery engine 310 delivers the selected advertisements for presentation to users on user devices, such as the user device 204.

The advertisement delivery system 202 may be configured to deliver advertisements within a number of different environments. For instance, advertisements may be delivered in conjunction with search results, on web pages, or within other electronic environments. In one embodiment, the advertisement delivery system 202 is configured to operate in coordination with a search engine 208 to provide advertisements in conjunction with search results in response to user queries from user devices, such as the user device 204. In such embodiments, a user may employ the user device 204 to enter a search query and submit the search query to the search engine 208. For instance, the user may employ a web browser on the user device 204 to access a search input web page of the search engine 208 and enter a search query. As another example, the user may enter a search query via a search input box provided by a search engine toolbar located, for instance, within a web browser, the desktop of the user device 204, or other location. One skilled in the art will recognize that a variety of other approaches may also be employed for providing a search query within the scope of embodiments of the present invention.

When the search engine 208 receives a search query from a user device, such as the user device 204, the search engine 208 performs a search on a search system index to identify relevant search results. Additionally, the advertisement delivery system 202 operates on the received search query and/or identified search results to select advertisements based on contextual relevance and/or monetization. In response to the search query, a search results page is provided to the user device 204 that includes search results and advertisements. Any combinatorial advertisements that have been selected are provided for presentation with the search results page.

In another embodiment, advertisements may be selected and presented on web pages, such as the web page 210a, hosted by the content server 210. For instance, the web page 210a may include an area for presenting advertisements delivered by the advertisement delivery system 202. In some embodiments, the advertisement delivery system 202 may select advertisements by analyzing the content of the web page 210a and selecting advertisements relevant to the content of the web page 210a. Advertisements may also be selected for the web page 210a based on monetization. When a user requests the web page 210a from the content server 210 using, for instance, a web browser on the user device 204, the web page 210a is provided to the user device for presentation to the user. Any combinatorial advertisements that have been selected are provided for presentation within the web page.

Although delivery of combinatorial advertisements has been discussed with reference to FIG. 2 in the context of search results and web pages, it should be understood that these are provided as examples only. As previously indicated, combinatorial advertisements may be provided in other electronic advertising environments (e.g., on-line games, advertising-supported software applications, emails etc.) within the scope of embodiments of the present invention.

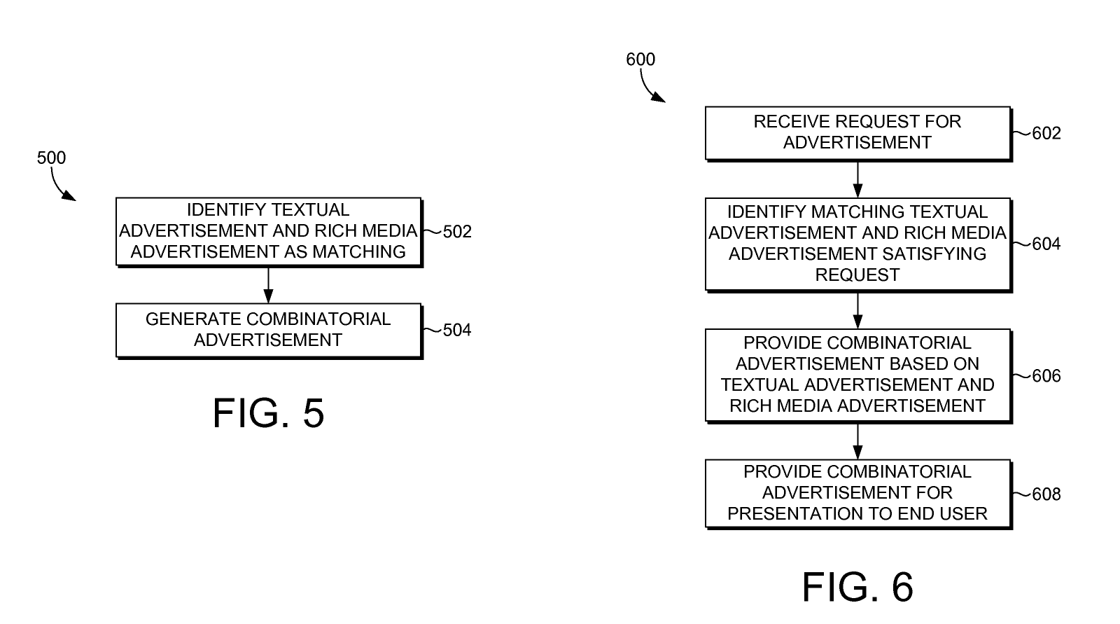

Referring now to FIG. 5, a flow diagram is provided that illustrates a method 500 for generating a combinatorial advertisement in accordance with an embodiment of the present invention. As shown in block 502, a textual advertisement and rich media advertisement are identified as matching. As noted previously, a textual advertisement and rich media advertisement may be identified as matching at any time in accordance with embodiments of the present invention. For instance, a textual advertisement and rich media advertisement may be identified as matching either in response to a request for an advertisement or independent of such a request.

The textual advertisement and rich media advertisement may be identified as matching based on an algorithm employing any of a variety of different factors. By way of example only and not limitation, the factors that may be employed to identify matching textual advertisements and rich media advertisements may include whether the advertisements correspond with the same advertiser, whether similar keywords were bid on for each advertisement, text included within each advertisement, as well as other metadata associated with the advertisements.

After identifying the textual advertisement and rich media advertisement as matching, a combinatorial advertisement is generated, as shown at block 504. As discussed previously, the combinatorial advertisement may be generated at any time in different embodiments, including in response to receiving a request for an advertisement and independent of such a request. The combinatorial advertisement is generated by including a text portion based on text from the textual advertisement and a rich media portion based on rich media from the rich media advertisement. In some embodiments, the combinatorial advertisement also includes an advertiser icon for the advertiser associated with the combinatorial advertisement. The advertiser icon may be based on an advertiser-provided icon or based on an icon retrieved from a web page associated with the advertiser, such as a favicon. In some embodiments, the combinatorial advertisement is also sized to occupy the space allocated within an electronic environment for a single advertisement. For instance, the electronic environment in which the combinatorial advertisement is to be presented may allocate a space for presenting an advertisement of a certain size. The combinatorial advertisement may be generated in accordance with that size such that the combinatorial advertisement only consumes the space allocated for a single advertisement.

Turning next to FIG. 6, a flow diagram is provided that illustrates a method 600 for providing a combinatorial advertisement in response to a request for advertisements in accordance with an embodiment of the present invention. As shown at block 602, a request for an advertisement is received. The request may be based on the need to present one or more advertisements in a particular environment, such as within a search results page, on a web page, or other environment. In some embodiments, the request may be a general request for any type of advertisement, including textual advertisements, rich media advertisements, and/or combinatorial advertisements. In other embodiments, the request may specifically request a combinatorial advertisement. The request may also specify other information for selecting advertisements for returning in response to the request, such as the number of advertisements to return and contextual information (e.g., keywords) regarding the environment in which the advertisements will be presented.

In response to the request, a matching textual advertisement and rich media advertisement satisfying the request are identified, as shown at block 604. In some embodiments, the textual advertisement and rich media advertisement may first each be separately identified as satisfying the request and then identified as matching, either based on a previous identification or a current analysis. In other embodiments, the textual advertisement and rich media advertisement may have been previously identified as matching and the combination of advertisements may be analyzed to identify the advertisements as satisfying the request. In further embodiments, either a textual advertisement or a rich media advertisement may be identified as satisfying the request and then a determination may be made identifying a matching advertisement. Any and all such variations are contemplated to be within the scope of embodiments of the present invention.

A combinatorial advertisement generated based on the matching textual advertisement and rich media advertisement is provided at block 606. In some embodiments, the combinatorial advertisement may have been generated and stored prior to receiving the request. In such embodiments, the combinatorial advertisement may be retrieved from storage at block 606. In other embodiments, the combinatorial advertisement may be generated on-the-fly at block 606 after receiving the request. The combinatorial advertisement is provided for presentation to an end user, as shown at block 608.

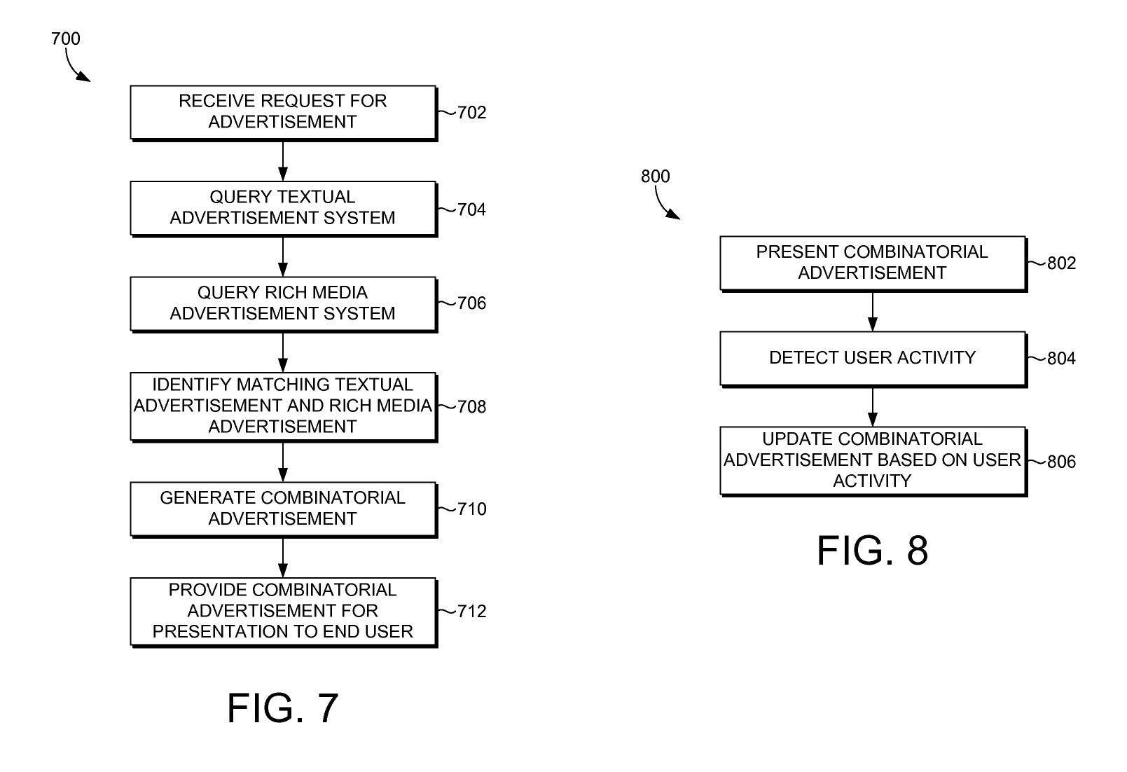

Some advertisement delivery systems may maintain separate systems and/or separate storages for textual advertisements and rich media advertisements. As such, in some embodiments, separate systems and/or storages may be separately queried to identify matching textual and rich media advertisements for providing combinatorial advertisements. Accordingly, FIG. 7 provides a flow diagram illustrating a method 700 for providing a combinatorial advertisement in response to a request for an advertisement in accordance with another embodiment of the present invention. As shown at block 702, a request for an advertisement is received. The request may include information that facilitates the selection of advertisements, such as contextual information regarding the environment in which the advertisements will be presented.

A textual advertisement storage system is queried at block 704 to identify textual advertisements satisfying the request. Additionally, a rich media advertisement storage system is queried at block 706 to identify rich media advertisements satisfying the request. Based on information returned from querying the two separate storage systems, a textual advertisement and rich media advertisement that satisfy the request are identified as matching, as shown at block 708.

A combinatorial advertisement is generated from the matching textual advertisement and rich media advertisement, as shown at block 710. The combinatorial advertisement includes a text portion derived from text of the textual advertisement and a rich media portion derived from rich media portion derived from rich media from the rich media advertisement. While the method indicates that a combinatorial advertisement is generated at block 710, in some embodiments, a previously generated combinatorial advertisement may be retrieved from storage at block 710. The combinatorial advertisement is provided for presentation to an end user at block 712.

In some embodiments of the present invention, a combinatorial advertisement that has been presented to an end user may be updated or otherwise modified based on user activity detected while the combinatorial advertisement is being presented to the end user. Accordingly, FIG. 8 provides a flow diagram showing a method 800 for updating a combinatorial advertisement based on user activity in accordance with an embodiment of the present invention. As shown in FIG. 8, a combinatorial advertisement is presented to an end user at block 802. The combinatorial advertisement may have been previously generated and provided for presentation to the end user in accordance with embodiments discussed hereinabove.

While the combinatorial advertisement is presented to the end user, user activity is detected, as shown at block 804. Generally, the user activity may be used as an indication of user interest to select different advertisements for presentation to the end user. In some embodiments, the user activity may be tracked and different advertisements identified based on the user activity using the techniques described in U.S. patent application Ser. No. 12/759,879, filed Apr. 14, 2010, and titled “Search Advertisement Selection based on User Actions,” which is hereby incorporated by reference in its entirety.

Based on the user activity detected at block 804, the presented combinatorial advertisement is updated, as shown at block 806. As noted above, the user activity is indicative or user interest and provides context for advertisement selection. In embodiments, the advertisement storage may be queried based on the context gleaned from the user activity to determine whether there are textual advertisements and/or rich media advertisements that match the textual advertisement and/or rich media advertisement used to generated to the currently presented combinatorial advertisement and that are relevant to the user context. For instance, a new textual advertisement may be identified that is determined to match the rich media advertisement (or the textual advertisement) used to generate the currently displayed combinatorial advertisement. The combinatorial advertisement may then be updated by replacing the currently displayed text with text from the new textual advertisement. Alternatively, a new rich media advertisement may be identified that is determined to match the textual advertisement (or the rich media advertisement) used to generate the currently displayed combinatorial advertisement. The combinatorial advertisement may then be updated by replacing the rich media from the previous rich media advertisement with rich media from the new rich media advertisement. In some embodiments, the combinatorial advertisement is updated by simply adding additional content from a new textual advertisement and/or a new rich media advertisement without removing content from the combinatorial advertisement from the previous textual advertisement and rich media advertisement.

In some embodiments, multiple new textual advertisements and/or rich media advertisements may be identified responsive to user activity. In such embodiments, the new textual advertisements and/or rich media advertisements may be ranked against one another based on relevance to the user context gleaned from the user activity, and the highest ranking advertisements may be used to update the combinatorial advertisement. In some embodiments, new textual advertisements and/or rich media advertisements may be compared against the textual advertisement and/or rich media advertisement originally used to generate the combinatorial advertisement to determine whether the new advertisements are more relevant to the user context gleaned from the user activity to determine whether the combinatorial advertisement should be updated.

As can be understood, embodiments of the present invention are directed to providing combinatorial advertisement generated based on text from a textual advertisement and rich media from a rich media advertisement. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, cause the one or more computing devices to perform a method comprising:
identifying a textual advertisement and rich media advertisement as matching; and
generating a combinatorial advertisement based on identifying the textual advertisement and rich media advertisement as matching, the combinatorial advertisement including a text portion based on text from the textual advertisement and a rich media portion based on rich media from the rich media advertisement.

2. The one or more computer-readable media of claim 1, wherein the textual advertisement and rich media advertisement are identified as matching based on an indication provided by an advertiser who provided the textual advertisement and rich media advertisement.

3. The one or more computer-readable media of claim 1, wherein the textual advertisement and rich media advertisement are automatically determined as matching based on one or more of the following: an advertiser who provided each advertisement, bidded keywords for each advertisement, text of each advertisement, and metadata associated with each advertisement.

4. The one or more computer-readable media of claim 1, wherein the rich media advertisement comprises a video and the rich media portion of the combinatorial advertisement comprises the video.

5. The one or more computer-readable media of claim 1, wherein the method further comprises:
receiving a request for an advertisement; and
providing the combinatorial advertisement for presentation to an end user in response to the request.

6. The one or more computer-readable media of claim 5, wherein the textual advertisement and rich media advertisement are identified as matching and the combinatorial advertisement is generated and stored prior to receiving the request for an advertisement, and wherein providing the combinatorial advertisement for presentation to the end user comprises retrieving the combinatorial advertisement from storage.

7. The one or more computer-readable media of claim 5, wherein the textual advertisement and rich media advertisement are identified as matching and the combinatorial advertisement is generated after receiving the request for an advertisement.

8. The one or more computer-readable media of claim 1, wherein the method further comprises retrieving an advertiser icon, and wherein generating the combinatorial advertisement comprises including the advertiser icon within the combinatorial advertisement.

9. The one or more computer-readable media of claim 1, wherein the advertiser icon comprises a favicon retrieved from a web page associated with the advertiser.

10. One or more computer-readable media storing computer-useable instructions that, when used by one or more computing devices, cause the one or more computing devices to perform a method comprising:
receiving a request for an advertisement;
identifying a textual advertisement and a rich media advertisement as matching and as satisfying the request;
providing a combinatorial advertisement based on the textual advertisement and the rich media advertisement, the combinatorial advertisement including a text portion based on text from the textual advertisement and a rich media portion based on rich media from the rich media advertisement; and
providing the combinatorial advertisement for presentation to an end user.

11. The one or more computer-readable media of claim 10, wherein the method further comprises identifying a second rich media advertisement as matching and as satisfying the request, wherein the combinatorial advertisement includes a second rich media portion based on rich media from the second rich media advertisement.

12. The one or more computer-readable media of claim 10, wherein the method further comprises:
detecting user activity; and
updating the combinatorial advertisement based on the user activity.

13. The one or more computer-readable media of claim 12, wherein updating the combinatorial advertisement comprises:
identifying a new rich media advertisement based on the user activity; and
replacing the rich media portion with a new rich media portion based on new rich media from the new rich media advertisement.

14. The one or more computer-readable media of claim 12, wherein updating the combinatorial advertisement comprises:
identifying a new textual advertisement based on the user activity; and
replacing the text portion with a new text portion based on new text from the new textual advertisement.

15. One or more computer-readable media storing computer-useable instructions that, when used by one or more computing devices, cause the one or more computing devices to provide a combinatorial advertisement, the combinatorial advertisement comprising:
a text portion comprising text derived from a textual advertisement; and
a rich media portion comprising rich media derived from a rich media advertisement,
wherein the combinatorial advertisement is generated based on a determination that the textual advertisement and rich media advertisement are matching.

16. The one or more computer-readable media of claim 15, wherein the rich media advertisement comprises a video, and wherein the rich media of the rich media portion comprises the video.

17. The one or more computer-readable media of claim 15, wherein the combinatorial advertisement further comprises an advertiser icon.

18. The one or more computer-readable media of claim 17, wherein the advertiser icon comprises a favicon retrieved from a web page associated with the advertiser.

19. The one or more computer-readable media of claim 15, wherein the text portion includes an advertisement title, advertisement body text, and a URL associated with the advertisement.

20. The one or more computer-readable media of claim 15, wherein the rich media portion comprises a rich media icon that when selected causes the rich media to be presented.
